(19) United States
(12) Patent Application Publication
(10) Pub. No.: US 2012/0089948 A1
(43) Pub. Date: Apr. 12, 2012

(54) GESTURE CONTROLLED USER INTERFACE

(75) Inventors: Chuin Kiat LIM, (US); Jiew Liang LOI, (US); Frank Howard LEVINSON, The Centris (SG)

(73) Assignee: THIRD WAVE POWER PTE LTD, (SG)

(21) Appl. No.: 13/270,781

(22) Filed: Oct. 11, 2011

Related U.S. Application Data
(60) Provisional application No. 61/391,746, filed on Oct. 11, 2010.

(51) Int. Cl. G06F 3/048

(52) U.S. Cl. 715/846

(57) ABSTRACT

In an embodiment, a device is described that includes a computer-readable medium, a processing device, and an MCUI. The processing device may be configured to execute computer-executable instructions stored on the computer-readable medium. The MCUI may include computer-executable instructions stored on the computer-readable medium. The computer-executable instructions may include instructions for processing data representing movement of the device to actuate one or more features of the device. Each feature may be designated on the device by a corresponding feature icon. The computer-executable instructions may also include instructions for providing, on the device, an indication of which feature is actuated on the device. The indication may be associated with a feature icon corresponding to an actuated feature.

### CROSS-REFERENCE TO RELATED APPLICATIONS

This patent application claims the benefit of and priority to U.S. Provisional Application N. 61/391,746 filed on Oct. 11, 2010 which is incorporated herein by specific reference in its entirety.

### BACKGROUND

Technology has developed to be useful in many fundamental capacities. This has meant that many devices can be useful to users in many different countries. In such circumstances, devices require different languages to be utilized in order for users of different language ability to use a device. Thus, some technology developed for an English-speaking user, for example, will not be directly usable for a Chinese-speaking user.

Further, in many cases technology requires that the user be literate. However, many potential users of technology, such as handheld devices, do not understand the language of the device, or are illiterate. Many of the useable functions of a handheld device, such as a radio, a flashlight, and the like, do not necessarily require a user to be literate or able to read any specific language.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF SOME EXAMPLE EMBODIMENTS

Techniques described herein generally relate to a motion controller user interface (MCUI).

In an embodiment, a device is described that includes a computer-readable medium, a processing device, and an MCUI. The processing device may be configured to execute computer-executable instructions stored on the computer-readable medium. The MCUI may include computer-executable instructions stored on the computer-readable medium. The computer-executable instructions may include instructions for processing data representing movement of the device to actuate one or more features of the device. Each feature may be designated on the device by a corresponding feature icon. The computer-executable instructions may also include instructions for providing, on the device, an indication of which feature is actuated on the device. The indication may be associated with a feature icon corresponding to an actuated feature.

In an embodiment, a method of actuating a feature of a device is described. The method may include assigning one or more directional movements to one or more features of the device. The method may also include displaying one or more feature icons, each associated with a corresponding feature and assigned directional movement. The method may also include detecting a particular one of the one or more directional movements along one or more axes of the device. The method may also include actuating a corresponding feature to which the detected directional movement is assigned.

In an embodiment, a device is described that includes a movement-controlled user interface, a processing device, a sensor, one or more motion actuated features, and one or more indicators. The processing device may be configured to actuate one or more features of the device. The sensor may be configured to gather data representing movement of the device. Each of the one or more motion actuated features may be configured to be actuated by the processing device in response to the processing device detecting a corresponding movement of the device that is assigned to the motion actuated feature. The processing device may detect the corresponding movement by analyzing the data gathered by the sensor. Each of the one or more indicators may be associated with a corresponding one of the one or more features and may be configured to indicate when the corresponding one of the one or more features is currently actuated.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A is a depiction of a device with graphic icons and features wherein a user can control the device through an MCUI of the device;

FIG. 1B is a depiction of a side view of the device of FIG. 1A with certain features shown;

FIG. 1C is a depiction of another side view of the device of FIG. 1A with certain features shown;

FIG. 2 is a depiction of internal components of the device of FIG. 1A;

FIG. 3 is a depiction of a clock-face arrangement of an example MCUI that can be included in the device of FIG. 1A depicting features that can be actuated by performing a tilting movement to an associated clock-hour position;

FIG. 4A is a depiction of a clock-face arrangement of an MCUI showing icons and indicators that can each be associated with an MCUI feature actuated by performing a tilting movement to an associated clock-hour position;

FIG. 4B is a flow chart of an example method of actuating a feature by performing an associated movement using the MCUI in the device of FIG. 1A;

FIG. 4C a depiction of other icons options that can be associated with features actuated by performing an associated movement in the device of FIG. 1A;

FIG. 5 is a depiction of a time of day clock feature that can be included in the device of FIG. 1A;

FIG. 6 is a depiction of a countdown timer feature that can be included in the device of FIG. 1A;

FIG. 7A is a depiction of a tilt meter feature that can be included in the device of FIG. 1A being used to gauge the existence and direction of slope on a table.

FIG. 7B is a depiction of the tilt meter feature of FIG. 7A detecting when a surface is flat without a slope;

FIG. 7C is a depiction of the tilt meter feature of FIG. 7A detecting when a surface is not flat with a slope;

FIG. 8 is a depiction of a weighing scale feature that can be included in the device of FIG. 1A; and

FIG. 9 is a depiction of photovoltaic (PV) cells used to absorb energy for device use that may be included in the device of FIG. 1A;

all arranged in accordance with at least one of the embodiments described herein, and which arrangement may be modified in accordance with the disclosure provided herein by one of ordinary skill in the art.

### DETAILED DESCRIPTION OF SOME EXAMPLE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It is to be understood that the drawings are diagrammatic and schematic representations of such exemplary embodiments, and are not limiting of the present invention, nor are they necessarily drawn to scale. It will also be understood that reference to an element as a first, or a second, etc. element, for example a first fluid line or a second fluid line, in the claims and in this description are not meant to imply sequential ordering unless explicitly stated, but rather are meant to distinguish one element from another element.

Some embodiments disclosed herein relate to a device and user interface that are controlled by various directional movements of the device performed by a user of the device and user interface (UI). The device may be a handheld device. In some embodiments, the device uses an interface which can be described as a motion-controlled user interface, or an MCUI. The MCUI, as described herein, may be structured such that the user need not understand any particular language to be able to use the device. The MCUI can use graphical icons, indicators, and movements associated with features of the device. As will be appreciated, such a device and user interface can be beneficial to users who are illiterate, or any user regardless of language reading ability. Alternately or additionally, embodiments of the device and user interface described herein may be used by other users preferring a device with useful features.

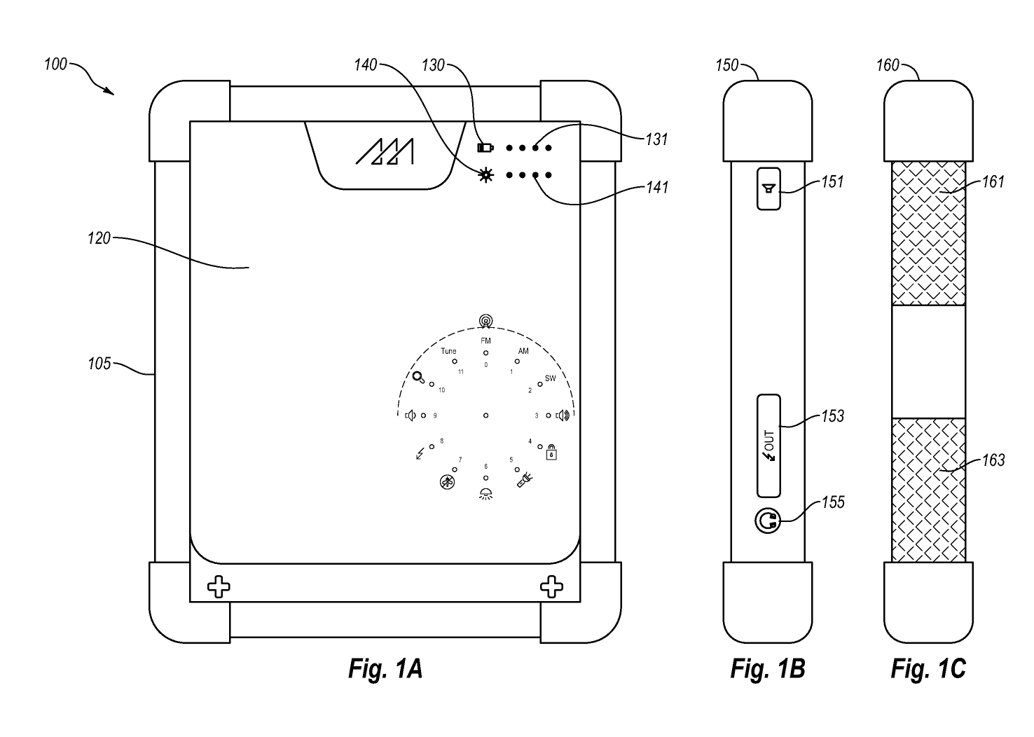

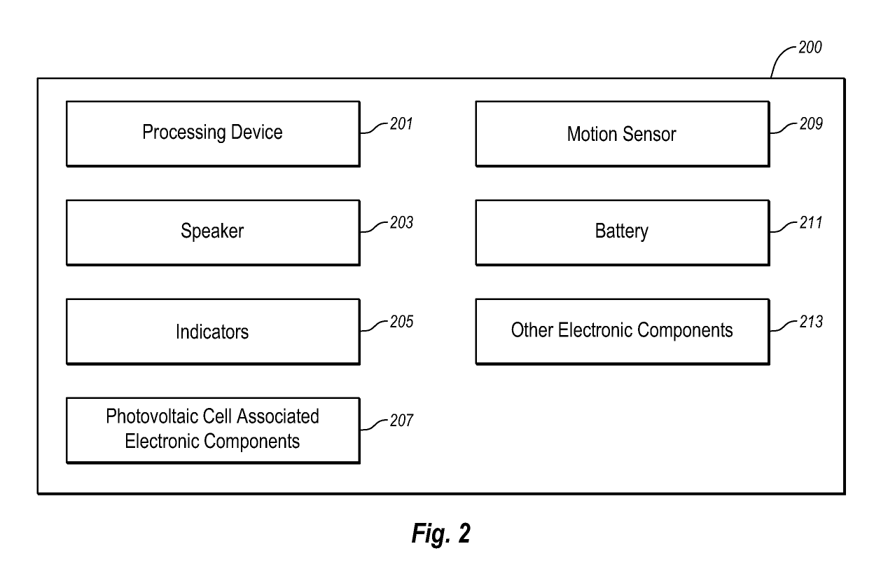

Referencing first FIG. 1A, an embodiment of a device 100 with graphic icons and features where a user can control the device through an MCUI of the device is shown. The device 100 includes an arrangement of icons that will be further described below. Each icon may represent a feature of the device 100. As illustrated, the device 100 includes an exterior case 105. The exterior case 105 may be made of an inexpensive clear plastic or polymer such as a polycarbonate, other thermoplastic, or the like. Advantageously, the case 105 can provide a seal for various internal electronics of the device 100, described in relation to FIG. 2 below, to protect internal electronics from ingress of various environmental elements.

FIG. 1A also depicts an example embodiment of an MCUI 120 arrangement including various elements such as icons, features, logos, and the like, although other arrangements are contemplated. The MCUI 120 can be operated by directional movements made by the user to the device 100 as will be explained in more detail to follow. The MCUI 120 includes a configuration of icons or symbols, and indicators, such as Light Emitting Diodes (LEDs), which advantageously allow the user to control the device 100 through interaction with the MCUI 120 based on movements rather than responses to written script. Accordingly, a user who is illiterate or who cannot read a particular language can use the device 100 through interaction with the MCUI 120. Further, since the MCUI 120 does not include components which may be expensive such as mechanical switches, physical keypads, and the like, the MCUI 120 can be inexpensive to implement on a device such as the device 100. Further, the lack of components such as mechanical switches, physical keypads, and the like enables better sealing of the case 105 against ingress of various environmental elements. In another embodiment, the exterior case 105 may include some transparent openings or transparent viewing windows for LED's to be visible to the user. In another embodiment, LED's, graphic icons, and the like can be configured in a different arrangement than shown in FIG. 1A.

In addition, the arrangement depicted in FIG. 1A depicts one embodiment of icons that may or may not be associated with a movement such as a battery icon 130 and a charge-strength icon 140. In one embodiment, next to or near the battery icon 130 are shown a battery-charge LED set 131 representing the level of electric charge remaining on the battery discussed in FIG. 2. In one embodiment, the right most LED of the battery-charge LED set 131 may be lit when the battery contains a high amount of electric charge relative to the battery's charge capacity, a middle LED of the battery-charge LED set 131 may be lit when the battery contains a lesser amount of charge relative to the battery's charge capacity, and the left most LED of the battery-charge LED set 131 may be lit when the battery contains a very small amount of charge relative to the battery's charge capacity. In some embodiments, the left most LED of the battery-charge LED set 131 may flash when the battery power is near to completely depleted

In addition to the battery icon 130 and the set of battery charge LEDs 131, FIG. 1 depicts the charge-strength icon 140 representing a strength of charge being absorbed by PV cells used to charge the device 100 and a set of charge strength LEDs 141. In some embodiments, the right most LED of the charge-strength LED set 141 may be lit when the PV cells are absorbing a high amount of solar power, a middle LED of the charge-strength LED set 141 may be lit when the PV cells are absorbing a lesser amount of solar power that is sufficient for the conversion to electric energy, and the left most LED of the charge-strength LED set 141 may be lit when the PV cells are not absorbing enough solar power to convert to electric energy.

Optionally, the MCUI 120 can include one or more directional stencils that includes directional markers such as, but not limited to, arrows that indicate how the device 100 may transition from one function to another as will be explained in more detail to follow. The arrows of the directional stencils can point to various LEDs that light up when a corresponding function is being performed by the device 100.

FIG. 1B is a depiction of a side view 150 of the device 100 of FIG. 1A with certain features shown. The side view 150 depicts one configuration of features, explained further below, that may be accessibly located on one side of the device 100 such as a speaker output 151, an universal serial bus (USB) charging port 153, and an audio output such as a headphone output 155. The speaker output 151 allows the user to listen to any audio output without requiring any external listening means such as headphones, in addition to being useful for an audio insect repellant. The USB charging port 153 may be used to charge an external device such as a communication device, including a mobile phone; a camera; a media player; a flashlight; a radio; and the like. The audio output 155 may be used to export audio data, and in one embodiment is a headphone output. Although FIG. 1B depicts features 151, 153, and 155 as being located on the side of the device 100, any of these features can be located elsewhere on the device 100.

FIG. 1C is a depiction of another side view 160, opposite of the side view 150 in FIG. 1B, of the device 100. The side view 160 depicts one configuration of features that may be accessibly located on one side of the device 100 such as a reading lamp 161, and a flashlight, or torch, 163. The reading lamp 161 may be configured to illuminate a large area near the device 100 for use in reading, for instance. The flashlight 163 may be configured to provide a focused beam of light for illuminating an area farther from the device 100. A flashlight is sometimes termed a “torch,” and both terms are used interchangeably below. Although FIG. 1C depicts features 161 and 163 as being located on a side of the device 100, any of these features can be located elsewhere on the device 100.

FIG. 2 is a depiction of internal components of the device 100 according to some embodiments. It will be appreciated that the internal components of the device 100 are typically enclosed within the exterior casing 105 (FIG. 1A) when the device 100 is fully assembled. A circuit board 200, which may be any reasonable circuit board, is used to connect the internal components. In the illustrated embodiment, the internal components include a processing device (block 201), an audio speaker (block 203), indicators such as LEDs (block 205), electronics associated with PV cells (block 207), a motion sensor (block 209), a battery (block 211), and electronic components associated with various features (block 213). The processing device (block 201) can include any programmable device with programmable input/output peripherals such as processor, a microprocessor, a controller, a microcontroller, a computing system, a computing device, or the like, and in one embodiment may be a Microchip PIC 18 family part. The processing device (block 201) is configured to provide processing and control to the other elements of the device 100 as needed. For example, the processing device (block 201) may detect device movement by analyzing data gathered by the motion sensor (block 209), may actuate the LEDs (block 205) associated with the device movement, may actuate features associated with the device movement, and may actuate LEDs associated with non-movement features such as battery charge display or charge-strength display.

In some embodiments, the speaker (block 203) may be included for use with one or more of various audio features, such as radio, audio insect repellant, or the like. Alternately or additionally, the electronics associated with the PV cells (block 207) may include charge controllers, inverters, wiring, and the like. Alternately or additionally, the motion sensor (block 209) may include an accelerometer, a gyroscope, or the like. The accelerometer may be a 2 or 3-axis accelerometer configured to sense the directional movements of the device 100, made by the user, to change the functionality of the device 100. In another embodiment, the battery (block 211) may include a storage battery of electrochemical cells such as a lead-acid battery, a nickel cadmium batter, a nickel metal hydride battery, a lithium ion battery, a lithium ion polymer battery, or the like. In another embodiment, other electronics (block 213) may include any electronic components needed by the other features such as one or more of a reading lamp, a flashlight, and a USB connector to operate such as electric wiring, coupling devices, light sources such as LED's or incandescent light bulbs, resistors, USB housings, or the like.

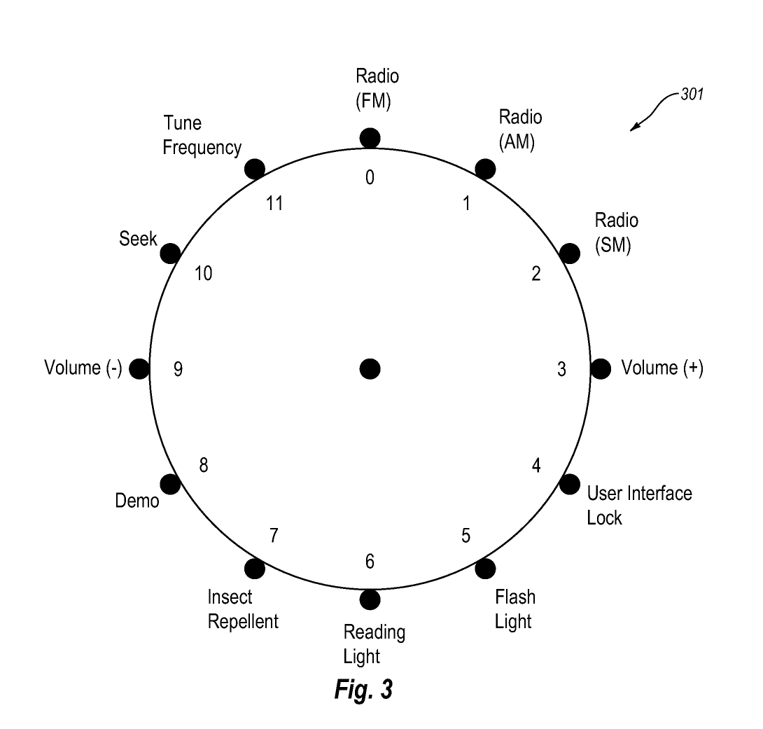

FIG. 3 depicts a clock-face arrangement 301 of an example embodiment of the MCUI 120 depicting feauters that can be actuated by performing a tilting movement to an associated clock-hour position. The clock-face arrangement 301 can allow for intuitive use by placing various features at each clock-hour position. In some embodiments, a user can use the clock-face arrangement 301 with a feature indicated by each clock-hour position by tilting the device in the direction of a clock-hour and associated feature. Although FIG. 3 shows one embodiment of a particular arrangement of features to each clock-hour position, other embodiments with different arrangements are possible.

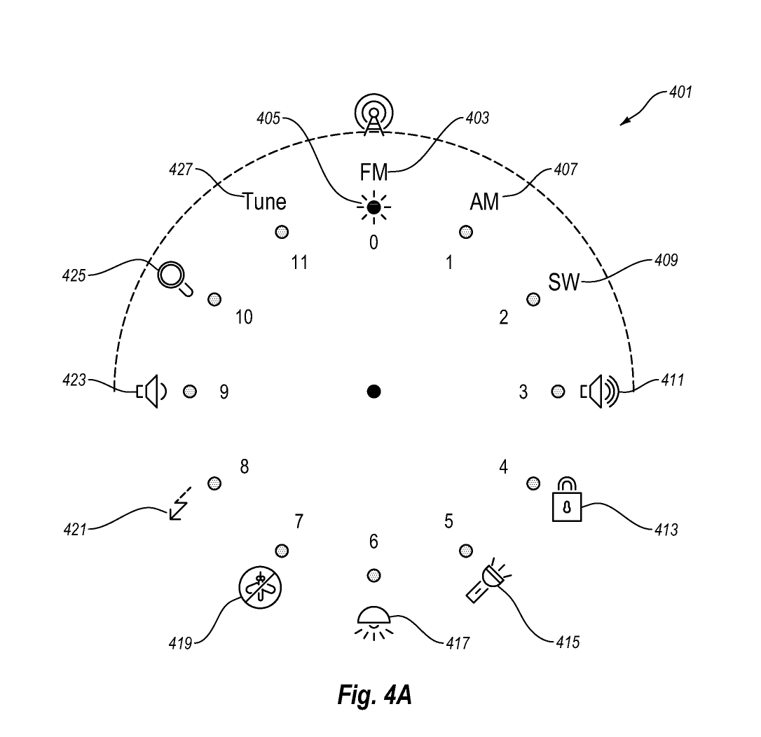

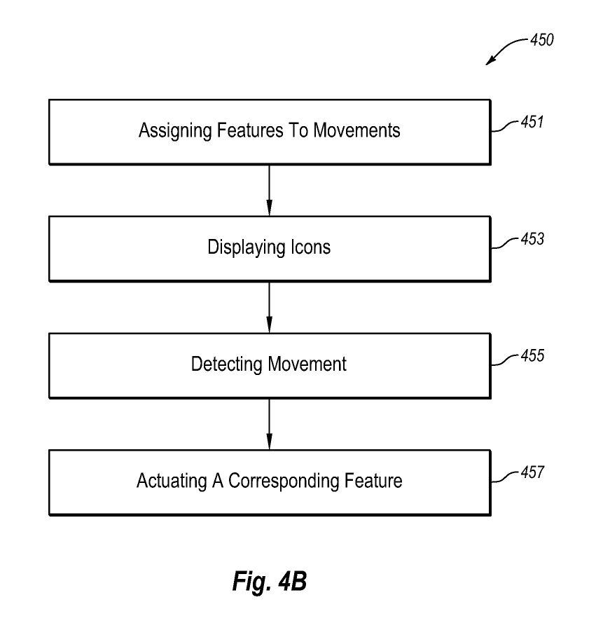

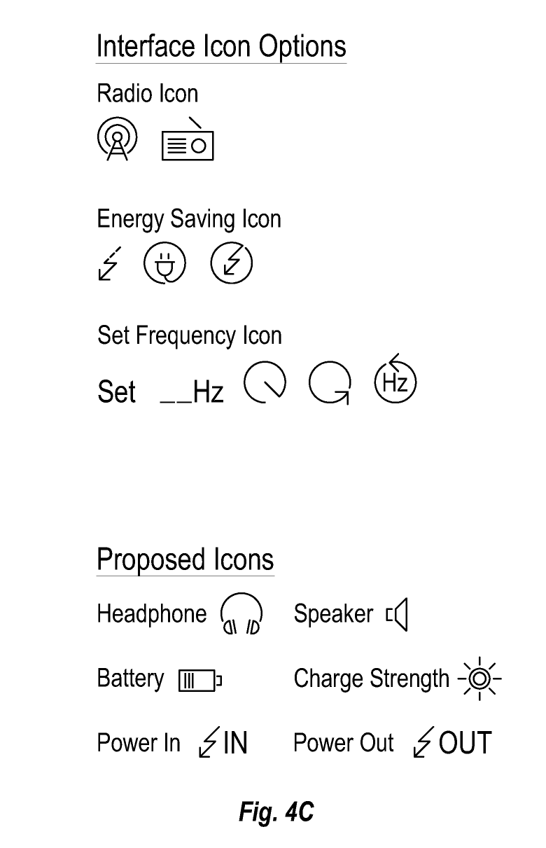

FIG. 4A depicts a clock-face arrangement 401 of an example embodiment of the MCUI 120 showing icons and indicators that can each be associated with an MCUI feature actuated by performing a tilting movement to an associated clock-hour position. The icon-based clock-face arrangement 401 associates a feature with a clock-hour position and an LED. For example, in the illustrate embodiment, an frequency modulated (FM) radio feature can be associated with the zero/twelve o'clock position, an FM radio icon 403, and an LED associated with the zero/twelve o'clock position 405. Similarly, each clock-hour position is associated with a feature, a feature icon, and an LED configured to illuminate when the associated feature is actuated.

For instance, as shown in FIG. 4A, the one o'clock position can be associated with an amplitude modulated (AM) radio feature and icon 407, the two o'clock position can be associated with a short-wave (SW) feature and icon 409, the three o'clock position can be associated with a volume increase feature and icon 411, the four o'clock position can be associated with a user interface locking feature and icon 413, the five o'clock position can be associated with a flashlight feature and icon 415, the six o'clock position can be associated with a reading lamp feature and icon 417, the seven o'clock position can be associated with an audio insect repellant feature and icon 419, the eight o'clock position can be associated with an energy output feature and icon 421, the nine o'clock position can be associated with a volume decrease feature and icon 423, the ten o'clock position can be associated with a radio frequency seek feature and icon 425, and the eleven o'clock position can be associated with a radio frequency manual tuning feature and icon 427. Although FIG. 4A depicts the icon-based clock-face arrangement 401 with specific icons and features associated with each clock-hour position, additional embodiments are conceivable, and FIG. 4A should not be considered limiting to other arrangements.

FIG. 4B is a flowchart of an example method 450 for actuating a feature of a device. First, a feature of an MCUI of the device is assigned to a directional movement (block 451). Next, one or more feature icons are displayed on the MCUI (block 453), each feature icon associated with a corresponding feature and an assigned directional movement. The directional movement of the device is detected (block 455) and a corresponding feature associated with the directional movement detected is actuated (block 457). In one embodiment, the directional movement can be associated with the icon-based clock-face arrangement 401 in FIG. 4A, such that a user can actuate any one feature represented by the feature icons by the directional movement of tilting the device 100 towards the feature icon. For example, if a user would like to actuate the FM radio feature associated with the FM feature icon 403 of FIG. 4A, the user may tilt the device 100 towards the twelve o'clock position and the FM radio feature icon 403. In some embodiments, the associated indicator LED 405 may then light up and the FM radio feature may actuate.

In some embodiments, the one or more features of the device may include, but are not limited to, volume adjustment, user interface lock, feature lock, seeking through next available radio frequencies, tuning to one or more radio frequencies, turning on the device, and turning off the device. A user interface lock function, associated with the user interface lock icon 413 of FIG. 4A, can lock the MCUI 120 to ignore subsequent motions of the device once the user interface lock function is actuated. For example, once the reading lamp feature is actuated by the method 450 described in FIG. 4B, the user can lock the user interface using the user interface lock function to ignore subsequent movements of the device 100 and the reading lamp will remain actuated. Optionally, a feature lock function can be provided on the device 100. The feature lock function may be similar to the user interface lock function in that the MCUI can be locked and thus ignore subsequent movements whether one feature is actuated or multiple features are actuated.

In some embodiments, a radio feature is described, and an FM feature, AM feature, and SW feature are associated with icon 403, icon 407, and icon 409, respectively. In addition, FIG. 4A depicts icons 425 and 427 that can be associated, in these and other embodiments, with selecting a radio frequency function. First, the available radio frequencies can be scanned with a radio seek function such that the user can seek out the next available radio station. In FIG. 4A the radio seek function may be associated with the radio frequency seek icon 425. Second, the user can tune the radio frequencies with a manual tuning function. In FIG. 4A, the radio seek function may be associated with the radio tuning feature icon 427. The radio feature may also associate clock positions with radio stations such that a selected radio station may be stored as a radio station preset. For example, a user may set one or more clock positions to directly tune to a desired radio station.

In some embodiments, other functions are not associated with an icon. An example of a function not associated with an icon may include turning the device 100 on and off. The device 100 can be turned on in some embodiments by shaking the device 100. The device 100 can be turned off in some embodiments by flipping the device 100 one-half rotation from a display of the MCUI 120 facing up, to a display of the MCUI 120 facing down. Alternatively, the device 100 can be turned off by quickly moving the device 100 downward. Other potential movements are contemplated in different embodiments to either turn the device 100 on or off such as: tapping the device 100, moving the device 100 quickly to a side, touching the device 100, picking up the device 100, rotating the device 100 one full rotation, and the like. In some embodiments, the device 100 may be turned on or off by rotating the device clockwise or counterclockwise mimicking a key lock movement.

FIG. 4C is a depiction of various icons that can alternately or additionally be associated with features actuated on a device with an MCUI, such as the device 100 and MCUI 120, by performing an associated movement of the device. For instance, FIG. 4C depicts two different icons, either of which might be associated with a radio feature. As another example, FIG. 4C additionally illustrates three icon options that might be associated with an energy saving feature. The options illustrated in FIG. 4C represent the flexibility of illustrations that may be used in order to designate to the user a feature that is represented by each icon. Other icon options are conceivable and FIG. 4C should not be considered to exclude other embodiments of icon illustration.

Reference will now be made to FIG. 1C and FIG. 4A where, in some embodiments, the reading lamp 161 shown in FIG. 1C is provided. The reading lamp 161 may be used to provide a small amount of reading light. In some embodiments, the reading lamp 161 may be a white light LED, although other light sources may alternately or additionally be used. The reading lamp 161 may be located at any location on the device 100 as needed. When the MCUI 120 is moved by a user motion to turn on the reading lamp function, the reading lamp LED 417, shown in FIG. 4A, may illuminate.

In another embodiment, as previously mentioned with respect to FIG. 1C, the flashlight 163 is provided. An icon 415 depicted in FIG. 4A indicates that the device 100 supports a flashlight that may be used to provide light that allows the user to see at night or to see in a dark location. In some embodiments, the flashlight 163 may be a red light LED, although other light sources may alternately or additionally be provided. The flashlight 163 may be located at any location on the device 100 as needed. When the MCUI 120 is moved by a user motion to turn on the flashlight 163 function, the flashlight LED 415, shown in FIG. 4A, may illuminate. In some embodiments, the flashlight 163 may be flashed as a beacon when needed such as during an emergency. In these and other embodiments, the device 100 is moved by a user directional motion to turn on the flashing 163 function and the indicator LED 415 may illuminate.

Alternately or additionally, the insect repellant feature may generate and emit a sound wave with a variable frequency to repel insects or animals. The insect repellant feature can cycle through a frequency range of 15 kilohertz (kHz)-18 kHz in some embodiments. In other embodiments, the insect repellant feature can cycle through different frequency ranges depending upon the response of one or more various types of insect or animals. By cycling through different frequencies, the range of insects repelled can be broadened compared to other systems in which a sound wave is emitted with a fixed frequency or frequencies. For example, some types of insects or animals may respond differently in different areas of the world, thus by cycling through different frequencies, the insect repellant feature may be adaptable to locations worldwide. In addition, cycling through different frequencies can reduce the rate of insect adaptation to any one specific frequency used. The insect repellant feature can be actuated by the method 450 above through an assigned directional movement. Although the range disclosed has been contemplated as an effective range, other ranges may be used in order to account for environmental variables that may dictate a need for a different range.

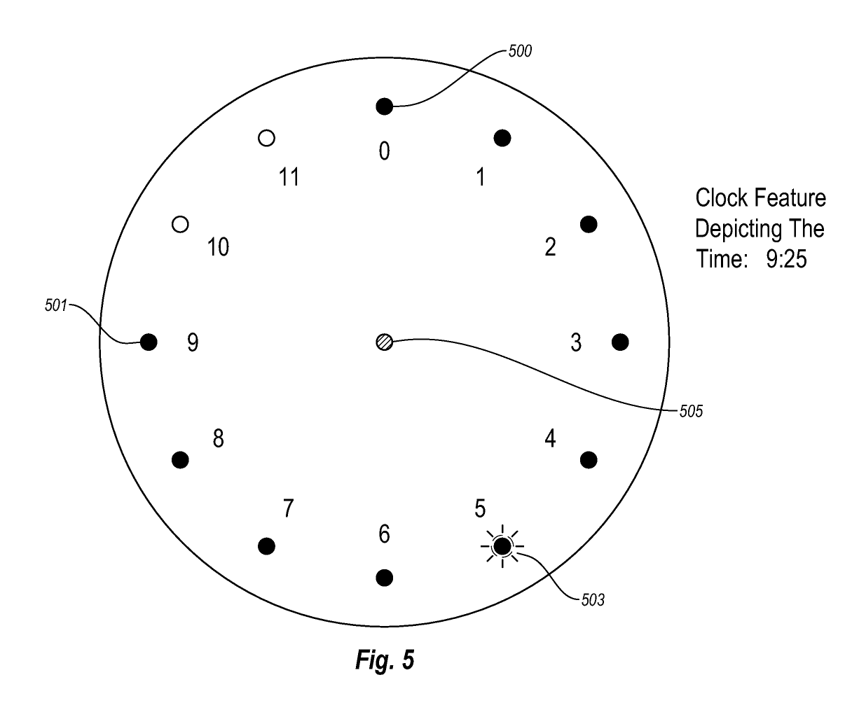

In some embodiments, shown in FIG. 5, the clock-face arrangement of the device 100 can alternately or additionally be used to depict the time of day. Using LEDs located at each clock hour position, the hour of day can be represented by illuminating all of the LEDs up until the current hour, while the current minute can be represented by flashing/blinking an individual LED, an LED of a different color, or a flashing/blinking LED of a different color indicating the nearest five minute interval. For example, in FIG. 5, a depiction of the clock-face arrangement is used to show the time 9:25, where all LEDs, from a zero/twelve o'clock position LED 500 through a nine o'clock position LED 501, are illuminated, while a five o'clock position LED 503 is either flashing/blinking, a different color than the other illuminated clock-hour LEDs, or both flashing/blinking and a different color. Alternately or additionally, a center LED 505 may be used to indicate morning or afternoon (e.g., a.m. or p.m.), by either flashing/blinking center LED 505 or the absence of flashing/blinking center LED 505 to indicate either a.m. or p.m., a different color center LED 505 to indicate a.m. than the color for p.m., or both flashing/blinking and a different color center LED 505 to indicate a difference between a.m. or p.m.

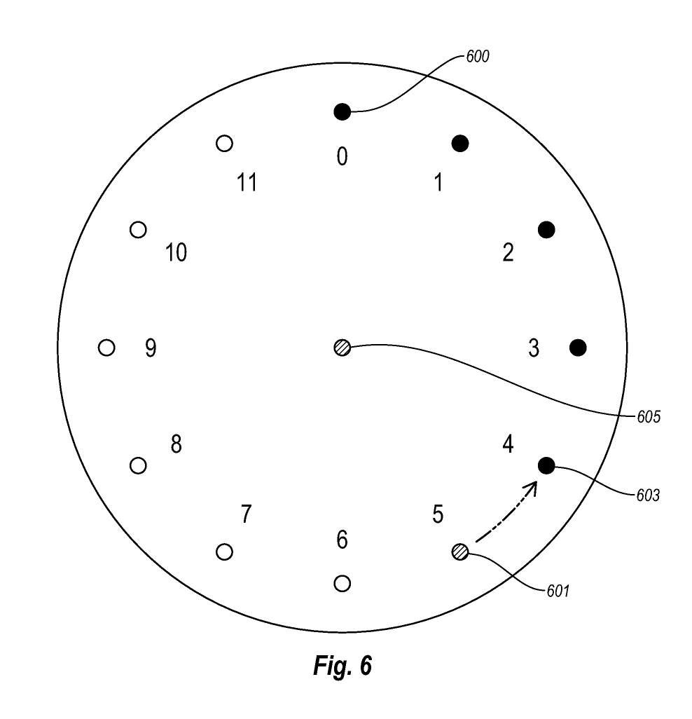

In some embodiments, FIG. 6 shows a timer function that can be included in the device 100 of FIG. 1A. Regarding FIG. 6, a user of the device can set a time from which the feature will countdown. A user may first select the time to be set, either in hours or in minutes. The time remaining may be designated by the remaining illuminated LEDs of the clock-face. For example, FIG. 6 shows a timer that may have been set to countdown from five minutes. At the beginning, the timer may show 5 minutes remaining by illuminating all LEDs from a zero/twelve o'clock position LED 600 through a nine o'clock position LED 601. After one minute has expired, the timer feature may discontinue illumination of the five o'clock position LED 601, leaving the zero/twelve o'clock position LEDs through a four o'clock position LED 603 illuminated. In addition, the center LED 605 may be used to indicate a timer feature counting down hours or a timer feature counting down minutes, by either flashing/blinking or the absence of flashing/blinking the center LED 605 to indicate either a.m. or p.m., a different color LED 605 than the associated clock position indicators (including LED 601, 604, in the example embodiment shown in FIG. 6) to indicate a.m. than the color for p.m., or both flashing/blinking and a different color center LED 605 to indicate a difference between a.m. or p.m.

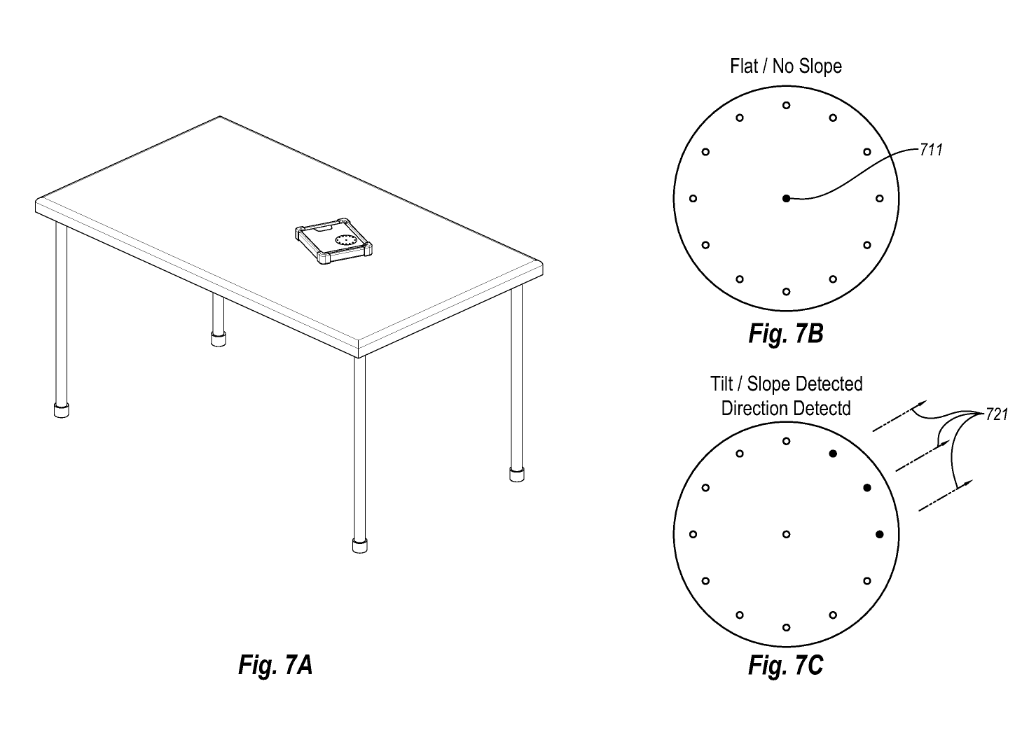

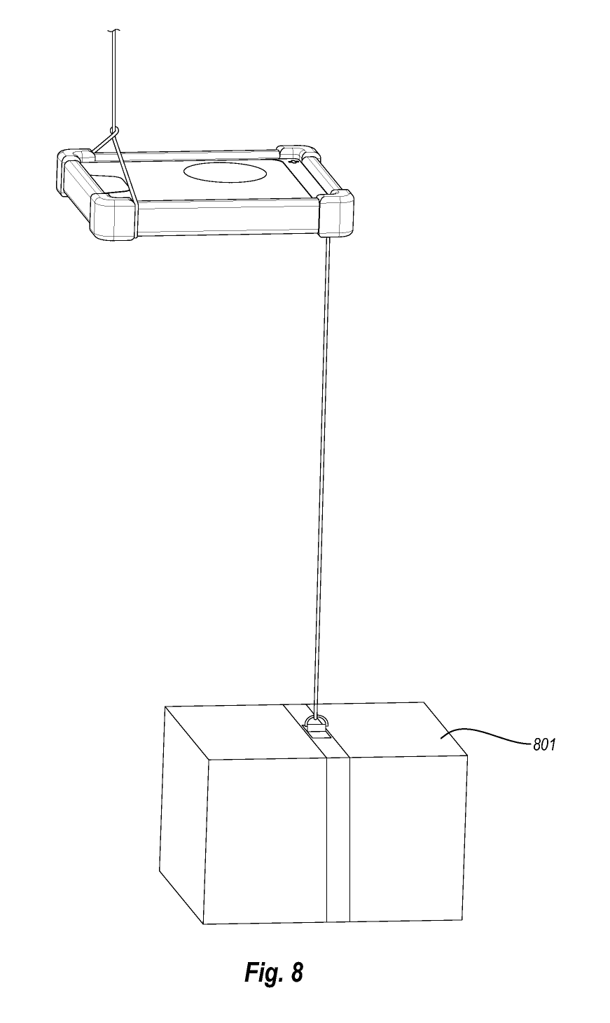

FIGS. 7A, 7B, and 7C show a tilt meter feature where, when the device 100 is placed on a surface, such as the table shown in FIG. 7A, the existence and direction of any tilt of the table (or more particularly, a surface of the table on which the device 00 is placed) is detected. As shown in FIG. 7B, when a measured surface is flat, without a slope or tilt, the center LED 711 in the middle of the clock-face arrangement can be illuminated to indicate that the measured surface is flat. In contrast, FIG. 7C shows an example clock face arrangement where the measured surface is not flat, or has a slope or tilt, and the LEDs illuminated exhibit the direction of the tilt or slope as depicted by the arrows 721.

FIG. 8 shows the device 100 being used as a scale to measure the weight of an object 801. In the example of FIG. 8, the device 100 may be hung on one side by a cord, a rope, or the like, and the object 801 can be attached to the opposite side of the device 100. As the object 801 moves the device 100 downward, a motion sensor measuring the force of the object 801 relative to a gravitational constant may be used to determine the weight of the object 801.

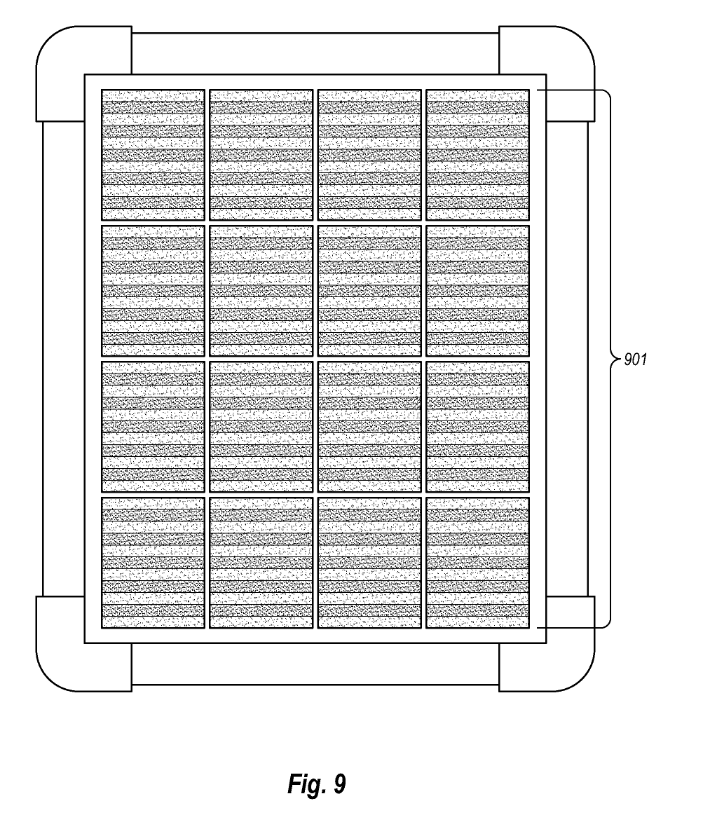

FIG. 9 is a depiction of PV cells used to absorb energy for device 100 use that may be included in the device 100 of FIG. 1A. Particularly, FIG. 9 shows an arrangement for one side opposite to the display side of the device being used primarily as an array of PV cells 901. Although other embodiments may include different arrangements, the arrangement shown in FIG. 9 is designed to use as much space on a backside of the device 100 as possible in order to maximize energy absorption through the array of PV cells 901.

In another example embodiment, a thermometer feature is disclosed. The device 100 may include the use of a thermistor to protect the device 100 from extreme temperatures. The thermometer feature may allow the user to read ambient temperature with the device 100 thermistor. For instance, the device 100 may convert a thermistor reading to an ambient temperature reading displayed to the user. The ambient temperature reading may be displayed with indicating LED's on the clock-face arrangement (shown in FIG. 4A), and sequentially flashing a first LED indicating a first digit of the ambient temperature reading, a second LED indicating a second digit of the ambient temperature reading, and a third LED indicating a third digit of the ambient temperature reading. The third LED may flash or blink to indicate that it represents the decimal point reading of the ambient temperature reading. For instance, to display a temperature of 68.2 degrees, the clock face LED at position #6 will light up, followed by the LED at position #8, followed by the LED at position #2 flashing. Additional digits may also be shown for ambient temperature readings of greater accuracy.

As discussed with respect to FIG. 2 above, embodiments also include a computer-readable medium for carrying or having computer-executable instructions or data structures stored thereon. Such computer-readable medium can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable medium.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A device comprising:
a computer-readable medium;
a processing device configured to execute computer-executable instructions stored on the computer-readable medium; and
a motion-controlled user interface including computer-executable instructions stored on the computer-readable medium, the computer-executable instructions including:
instructions for processing data representing movement of the device to actuate one or more features of the device, each feature being designated on the device by a corresponding feature icon; and
instructions for providing, on the device, an indication of which feature is actuated on the device, the indication being associated with a feature icon corresponding to an actuated feature.

2. The device of claim 1, wherein the one or more features comprise at least one of:
a reading light;
a flashlight;
a USB charging port;
a radio;
a light emitting diode (LED);
an acoustic insect repellant;
an audio headphone output;
an audio speaker;
a user interface demonstration sequence; or
a solar panel.

3. The device of claim 1, wherein the one or more features include one or more functions comprising at least one of:
volume adjustment;
user interface lock;
feature lock;
turning the device on;
seeking next available radio frequency;
tuning manually to one or more radio frequencies; and
turning the device off.

4. The device of claim 1, wherein the instructions for processing data representing movement of the device to actuate one or more features of the device include instructions for mapping each of a set of actions that can be performed on the device by a user to each of a set of features of the device, the set of actions and corresponding features including at least one of:
shaking the device to turn on the device;
tilting the device in the direction of a feature icon to actuate the associated feature;
flipping the device one-half rotation from a display of the device facing up to the display of the device facing down to turn off the device; or
quickly moving the device downward to turn off the device.

5. The device of claim 1, further comprising:
an accelerometer;
a battery;
a speaker; and
a photovoltaic cell.

6. The device of claim 1, wherein the motion-controlled user interface further includes a plurality of feature icons, each corresponding to one of the one or more features of the device, wherein the plurality of feature icons have a clock-face arrangement on a display of the device and correspond to features actuated as follows by a user:
an FM radio feature is actuated by tilting the device to a zero/twelve o'clock position;
an AM radio feature is actuated by tilting the device to a one o'clock position;
a shortwave (SW) radio feature is actuated by tilting the device to a two o'clock position;
a volume increase function is actuated by tilting the device to a three o'clock position;
a user interface lock function is actuated by tilting the device to a four o'clock position;
a flashlight feature is actuated by tilting the device to a five o'clock position;
a reading lamp feature is actuated by tilting the device to a six o'clock position;
an insect repellent feature is actuated by tilting the device to a seven o'clock position;
an user interface demonstration feature is actuated by tilting the device to an eight o'clock position;
a volume decrease function is actuated by tilting the device to a nine o'clock position;
a radio frequency seeking function is actuated by tilting the device to a ten o'clock position; and
a radio frequency manual tuning function is actuated by tilting the device to an eleven o'clock position.

7. The device of claim 1, further comprising one or more non-movement related icons, including at least one of:
a battery icon representing a level of charge remaining in a battery of the device;
an energy saving icon representing energy saving options of the device;
a set frequency icon representing a frequency at which a radio of the device is set;
a headphone icon configured to indicate when headphones are used with the device;
a speaker icon configured to indicate when a speaker of the device is in use;
a power-in icon representing when energy is being absorbed by a photovoltaic system of the device;
a power-out icon representing when energy is being transferred to another device; or
a charge strength icon representing an amount of power being absorbed by the photovoltaic system of the device.

8. The device of claim 1, further comprising at least one of:
a real-time clock, the real-time clock being shown on a clock face using either flashing LEDs to designate minutes, or a first color of LEDs to designate the hour, and a second color to designate the minutes;
a countdown timer, the countdown timer being shown on a clock face using LEDs to designate time remaining;
a tilt meter, the tilt meter designating the existence and direction of tilt of the device by illuminating at least one of multiple LEDs located at hour markers of the clock face, the tilt meter designating the nonexistence of tilt of the device on the clock face by illuminating an LED at the center of the clock face; and
a weighing scale, the weighing scale utilizing an accelerometer of the device to gauge the weight of an object during rotation of the accelerometer.

9. The device of claim 1, further comprising an insect repellant component configured to:
generate and emit a sound wave with a variable frequency, the frequency of the sound wave being cycled through a range of 15 kilohertz (kHz)-18 kHz to repel insects.

10. A method of actuating a feature of a device, comprising:
assigning one or more directional movements to one or more features of the device;
displaying one or more feature icons, each associated with a corresponding feature and assigned directional movement;
detecting a particular one of the one or more directional movements along one or more axes of the device; and
actuating a corresponding feature to which the detected directional movement is assigned.

11. The method of claim 10, wherein the one or more features comprise at least one of:
a reading light;
a flashlight;
a USB charging port;
a radio;
a light emitting diode (LED);
an acoustic insect repellant;
an audio headphone output;
an audio speaker;
a user interface demonstration sequence;
a clock;
a tilt meter measuring the tilt of a surface relative to a gravitational constant,
a timer;
a weight scale; or
a solar panel.

12. The method of claim 10, wherein the one or more features includes one or more functions including at least one of:
volume adjustment;
user interface lock;
feature lock;
turning the device on;
seeking next available radio frequency;
tuning manually to one or more radio frequencies; or
turning the device off.

13. The method of claim 10, wherein the one or more directional movements assigned to the one or more features include one or more functions actuated by a user by at least one of:
shaking the device to turn on the device;
tilting the device in the direction of a feature icon to actuate the associated feature;
flipping the device one-half rotation from a display of the device facing up to the display of the device facing down to turn off the device; or quickly moving the device downward to turn off the device.

14. The method of claim 10, wherein the directional movements assigned to the one or more features include tilting a device to one or more positions in a clock-face arrangement to actuate one or more features, including:
an FM radio feature actuated by tilting the device to a zero/twelve o'clock position;
an AM radio feature actuated by tilting the device to a one o'clock position;
a shortwave (SW) radio feature actuated by tilting the device to a two o'clock position;
a volume increase function actuated by tilting the device to a three o'clock position;
a user interface lock function actuated by tilting the device to a four o'clock position;
a flashlight feature actuated by tilting the device to a five o'clock position;
a reading lamp feature actuated by tilting the device to a six o'clock position;
an insect repellent feature actuated by tilting the device to a seven o'clock position;
an user interface demonstration feature actuated by tilting a device to an eight o'clock position;
a volume decrease function actuated by tilting the device to a nine o'clock position;
a radio frequency seeking function actuated by tilting the device to a ten o'clock position; and
a radio frequency manual tuning function actuated by tilting the device to an eleven o'clock position.

15. The method of claim 10, further comprising:
generating and emitting a sound wave with a variable frequency to repel insects, the frequency of the sound wave being continuously cycled through a range of 15 kilohertz (kHz)-18 kHz.

16. A device, comprising:
a movement-controlled user interface;
a processing device configured to actuate one or more features of the device;
a sensor configured to gather data representing movement of the device;
one or more motion actuated features, wherein each of the one or more motion actuated features is configured to be actuated by the processing device in response to the processing device detecting a corresponding movement of the device that is assigned to the motion actuated feature, the processing device detecting the corresponding movement by analyzing the data gathered by the sensor; and
one or more indicators, each associated with a corresponding one of the one or more features and each configured to indicate when the corresponding one of the one or more features is currently actuated.

17. The device of claim 16, wherein the one or more indicators include a plurality of light emitting diodes (LEDs), each of the LEDs being associated with one of the one or more features and being located proximate a corresponding feature icon provided on a display of the device, wherein when a feature is currently actuated, the LED proximate the corresponding feature icon corresponding to the actuated feature lights up to indicate that the actuated feature is currently actuated.

18. The device of claim 16, wherein the one or more features comprise at least one of:
a reading light;
a flashlight;
a USB charging port;
a radio;
a light emitting diode (LED);
an acoustic insect repellant;
an audio headphone output;
an audio speaker;
a user interface demonstration sequence;
a solar panel;
volume adjustment;
user interface lock;
feature lock;
turning the device on;
seeking next available radio frequencies;
tuning manually to one or more radio frequencies; or turning the device off.

19. The device of claim 16, wherein the processor configured to actuate one or more features in response to the processing device detecting a corresponding movement of the device that is assigned to the motion actuated feature is actuated by the corresponding movements including at least one of:
an FM radio feature is actuated by tilting the device to a zero/twelve o'clock position;
an AM radio feature is actuated by tilting the device to a one o'clock position;
a shortwave (SW) radio feature is actuated by tilting the device to a two o'clock position;
a volume increase function is actuated by tilting the device to a three o'clock position;
a user interface lock function is actuated by tilting the device to a four o'clock position;
a flashlight feature is actuated by tilting the device to a five o'clock position;
a reading lamp feature is actuated by tilting the device to a six o'clock position;
an insect repellent feature is actuated by tilting the device to a seven o'clock position;
an user interface demonstration feature is actuated by tilting the device to an eight o'clock position;
a volume decrease function is actuated by tilting the device to a nine o'clock position;
a radio frequency seeking function is actuated by tilting the device to a ten o'clock position;
a radio frequency manual tuning function is actuated by tilting the device to an eleven o'clock position;
shaking the device to turn on the device;
tilting the device in the direction of a feature icon to actuate the associated feature;
flipping the device one half rotation from a display of the device facing up to the display of the device facing down to turn off the device; or
quickly moving the device downward to turn off the device.

20. The device of claim 16, further comprising one or more non-movement related icons, including at least one of:
a battery icon representing a level of charge remaining in a battery of the device;
an energy saving icon representing energy saving options of the device;
a set frequency icon representing a frequency at which a radio of the device is set;
a headphone icon configured to indicate when headphones are used with the device;
a speaker icon configured to indicate when a speaker of the device is in use;
a power-in icon representing when energy is being absorbed by a photovoltaic system of the device;
a power-out icon representing when energy is being transferred to another device; or
a charge strength icon representing an amount of power being absorbed by the photovoltaic system of the device.
